(19) United States
(12) Patent Application Publication
(10) Pub. No.: US 2016/0370693 A1
(43) Pub. Date: Dec. 22, 2016

(54) IMAGE DISPLAY DEVICE

(71) Applicant: OLYMPUS CORPORATION, Tokyo (JP)

(72) Inventor: Daichi WATANABE, Tokyo (JP)

(73) Assignee: OLYMPUS CORPORATION, Tokyo (JP)

(21) Appl. No.: 15/253,793

(22) Filed: Aug. 31, 2016

Related U.S. Application Data
(63) Continuation of application No. PCT/JP2015/000877, filed on Feb. 23, 2015.

(30) Foreign Application Priority Data
Mar. 27, 2014 (JP) 2014-066604

(51) Int. Cl. G03B 21/14; G02B 6/12; G02B 27/00

(52) U.S. Cl. CPC G03B 21/147; G02B 27/0081; G02B 6/12004

(57) ABSTRACT

An image display device, includes: a projection optical system projecting, at infinity, image light corresponding to an arbitrary image; and a first propagation optical system. The first propagation optical system includes: a first diffractive element diffracting the image light emitted from the projection optical system; a first light guide portion formed like a plate having a first plane and a second plane parallel and opposing to each other, the first light guide portion propagating in the first direction the image light deflected by the first diffractive element, between the first plane and the second plane while causing the image light to be repeatedly reflected therebetween; and a first triangular prism array deflecting through reflection or refraction, in a direction substantially perpendicular to the first plane, part of the image light propagating through the first light guide portion.

### CROSS REFERENCE TO RELATED APPLICATIONS

The present application is a Continuing Application based on International Application PCT/JP2015/000877 filed on Feb. 23, 2015, which in turn claims the priority from Japanese Patent Application No.2014-66604 filed on Mar. 27, 2014, the entire disclosure of these earlier applications being incorporated herein by reference.

### TECHNICAL FIELD

This disclosure relates to an image display device which expands an exit pupil to project an image.

### BACKGROUND

Various image display devices have been known as a device for projecting a two-dimensional image into a field of view of an observer, which causes image light emitted from a projection optical system projecting at infinity a virtual image of a display image, to be incident on a light guide plate to be repeatedly reflected within the light guide plate so as to propagate the image light, while emitting the image light which is deflected in part toward the observer's side on one surface side of the light guide plate, part of light which is deflected in part toward the observer's side on one surface side of the light guide plate, to thereby expand an exit pupil (see, for example, JP2010044326A (PTL 1)). The device according to PTL 1 is configured to define, based on the thickness of the light guide layer and the propagation angle, the width of a light flux incident on the light guide plate, so as to hardly cause luminance unevenness even when the pupil position has moved.

### CITATION LIST

### Patent Literature

PTL 1: JP2010044326A

### SUMMARY

It could therefore be helpful to provide an image display device, including: a projection optical system projecting, at infinity, image light corresponding to an arbitrary image; and a first propagation optical system,

the first propagation optical system including:

a first input deflector deflecting the image light emitted from the projection optical system;

a first light guide portion formed like a plate having a first plane and a second plane parallel and opposing to each other, the first light guide portion propagating in a first direction the image light deflected by the first input deflector, between the first plane and the second plane while causing the image light to be repeatedly reflected therebetween; and

a first output deflector deflecting through reflection or refraction, in a direction substantially perpendicular to the first plane, part of the image light propagating through the first light guide portion while deflecting the image light such that an incident angle at which the image light is incident on the first input deflector and an exit angle at which the image light having propagated through the light guide portion have a non-linear relation.

The projection optical system may preferably project image light corrected based on non-linearity between the incident angle at which the image light is incident on the first input deflector and the exit angle at which the image light having propagated through the first light guide portion is emitted from the first output deflector.

The image display device may further preferably include a second propagation optical system which includes:

a second input deflector diffracting the image light deflected by the first output deflector and emitted from the first propagation optical system;

a second light guide portion formed like a plate having a third plane and a fourth plane parallel and opposing to each other, the second light guide portion propagating, in a second direction substantially perpendicular to the first direction, the image light deflected by the second input deflector, between the third plane and the fourth plane while causing the image light to be repeatedly reflected therebetween; and

a second output deflector deflecting through reflection or refraction, in a direction substantially perpendicular to the third plane, part of the image light propagating through the second light guide portion.

The projection optical system may preferably project image light corrected based on non-linearity between an incident angle at which the image light is incident on the first input deflector and an exit angle at which the image light having propagated the light guide portion is emitted from the second output deflector.

Further, the first input deflector has a diffraction grating pattern periodically arranged in the first direction.

### BRIEF DESCRIPTION OF THE DRAWINGS

In the accompanying drawings:

FIG. 1 is a perspective view of the disclosed image display device according to Embodiment 1;

FIG. 2 is a schematic illustration of a configuration of the projection optical system of FIG. 1;

FIG. 3 is a perspective view showing respective components of the pupil expanding optical system of FIG. 1, as being spaced apart from one another;

FIG. 4 is a top view of the incident side part of a first propagation optical system, illustrated along with a path of the image light;

FIG. 5A illustrates a schematic configuration of the disclosed projection optical system together with an incident angle and an exit angle;

FIG. 5B illustrates a conventional projection optical system together with an incident angle and an exit angle;

FIG. 6A is for illustrating propagation of image light in the pupil expanding optical system of FIG. 1;

FIG. 6B is for illustrating propagation of image light in a conventional pupil expanding optical system;

FIG. 7 illustrates a schematic configuration of a modified example of the projection optical system together with a deflection angle and an exit angle of image light;

FIGS. 8A and 8B, each illustrate a schematic configuration of the disclosed image projection device according to Embodiment 2, in which FIG. 8A is a front view and FIG. 8B is a top view;

FIG. 9 is a top view of the incident part of the propagation optical system of FIG. 8A, illustrated along with a path of image light;

FIG. 10 illustrates a modified example of the disclosed propagation optical system;

FIG. 11 illustrates another modified example of the disclosed propagation optical system;

FIG. 12 illustrates further another modified example of the disclosed propagation optical system; and

FIG. 13 is a sectional view of the disclosed pupil expanding optical system according to Embodiment 3, along with an optical path of image light.

### DETAILED DESCRIPTION

The following describes embodiments of the disclosed device, with reference to the drawings.

### Embodiment 1

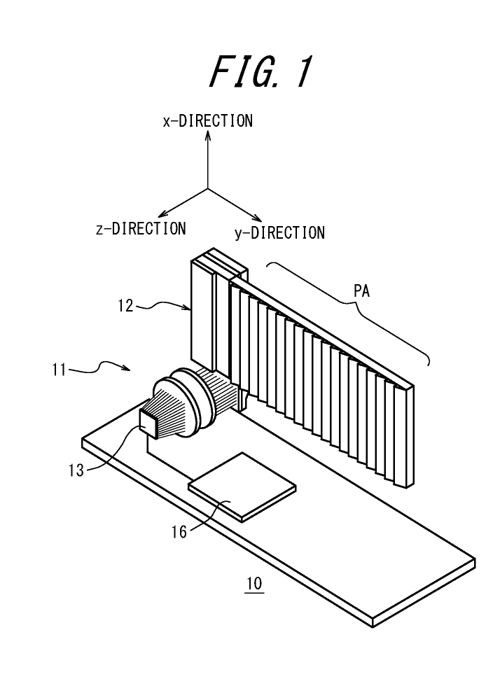

FIG. 1 is a perspective view of the disclosed image display device according to Embodiment 1.

As illustrated in FIG. 1, the image display device 10 is configured by including a projection optical system 11 and a pupil expanding optical system 12. In Embodiment 1, the direction along the optical axis of the projection optical system 11 is defined as z-direction and two directions perpendicular to each other and also perpendicular to the z-direction are each defined as x-direction (first direction) and y-direction (second direction), respectively. In FIG. 1, the x-direction is oriented upward. Further, in FIG. 1, the lower right diagonal direction is defined as the y-direction and the lower left diagonal direction is defined as the z-direction, in the vicinity of the pupil expanding optical system 12.

The projection optical system 11 projects, at infinity, image light corresponding to an arbitrary image. The pupil expanding optical system 12 receives image light projected by the projection optical system 11 and emits the light by expanding the exit pupil. The observer may focus on any position in the projection region PA of the expanded exit pupil, to thereby observe the image.

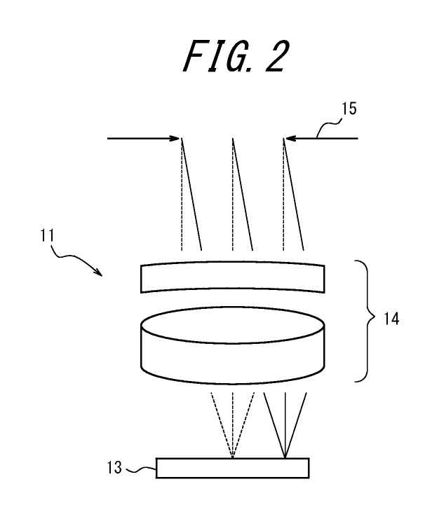

Next, a configuration of the projection optical system 11 is described. As illustrated in FIG. 2, the projection optical system 11 is configured by including: a LCD 13; and a collimator 14 composed of a small number of lenses. Further, the LCD 13 is connected to an image controller 16. The LCD 13 displays a display image, based on a signal from the image controller 16. Here, other display elements such as an organic EL device may be used in place of the LCD 13. Diverged light emitted from each pixel of the LCD 13 is converted into parallel light by the collimator 14. The collimator 14 forms an exit pupil 15, which is disposed so as to coincide with an incident plane of the pupil expanding optical system 12. The image controller 16 of FIG. 1 outputs an image signal to the LCD 13, the image signal being processed in advance so as to correct distortion in an image generated by a first propagation optical system 22 and a second propagation optical system 24 of the pupil expanding optical system 12 as will be described later.

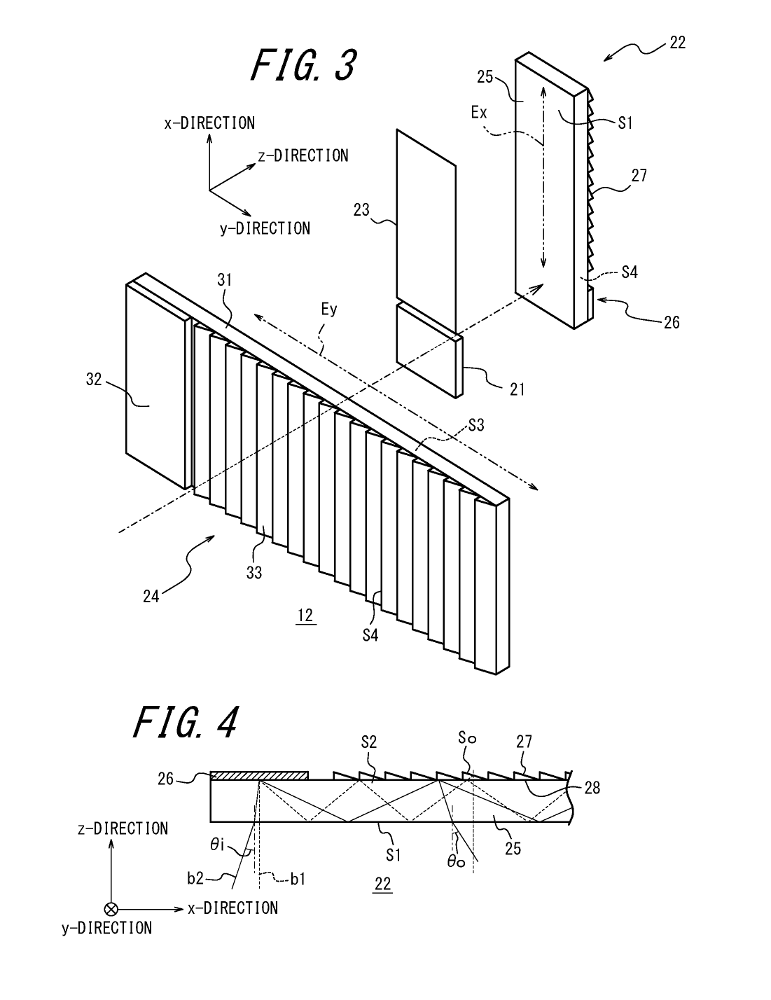

Next, a configuration of the pupil expanding optical system 12 is described with reference to FIG. 3. The pupil expanding optical system 12 is configured by including: a polarizer 21; a first propagation optical system 22; a half-wave plate 23; and a second propagation optical system 24. The polarizer 21, the first propagation optical system 22, the half-wave plate 23, and the second propagation optical system 24 of FIG. 3 are illustrated as largely spaced apart from one another for the sake of explanation, which are actually disposed adjacent to one another as illustrated in FIG. 1.

The polarizer 21 is disposed between the exit pupil 15 of the projection optical system 11 and the projection optical system 11, and receives image light emitted from the projection optical system 11 to emit S-polarized light. The first propagation optical system 22 is disposed such that an incident region of a first plane (see FIG. 4) of a first light guide portion 25 to be described layer coincides with the exit pupil 15 of the projection optical system 11, so as to expand, in the x-direction, an exit pupil projected by the polarizer 21 as S-polarized light, and emits the exit pupil thus expanded (see the reference symbol “Ex”). The half-wave plate 23 rotates, by 90°, the polarization plane of image light expanded in the x-direction. With the polarization plane being rotated by 90°, image light can be incident as S-polarized light onto the second propagation optical system 24. The second propagation optical system 24 expands, in the y-direction, image light having a polarization plane rotated by the half-wave plate 23, and emits the image light thus expanded (see the reference symbol “Ey”).

Next, description is given of the function of the first propagation optical system 22 for expanding the exit pupil, along with the configuration of the first propagation optical system 22. As illustrated in FIG. 4, the first propagation optical system 22 is configured by including: a first light guide portion 25; a first diffraction element 26 (first input deflector); a first prism array 27 (first output deflector); and a first polarization beam splitting film 28. Here, the first polarization beam splitting film 28 is evaporated onto the first light guide portion 25 as will be described later, which are thus inseparable from each other.

The first light guide portion 25 is a transmitting flat plate having a first plane S1 and a second plane S2 opposing and parallel to each other. The first diffractive element 26 is bonded, through a transparent adhesive, onto the second plane S2 of the first light guide portion 25, at the end on the image light emission side. Further, to the rest of the second plane S2 of the first light guide portion 25 where the first diffractive element 26 is not bonded, the first triangular prism array 27 is bonded through a transparent adhesive across the first polarization beam splitting film 28. Image light from the projection optical system 11 is incident on a region of the first plane S1 opposing to the first diffractive element 26, and thus, the region is referred to as incident region. Meanwhile, the region of the first plane S1 opposing to the first triangular prism array 27 is a region where image light propagating through the first light guide portion 25 is emitted, and thus the region is referred to as emitting region.

The first polarization beam splitting film 28 is a multilayer film designed to transmit light incident from a substantially perpendicular direction and to reflect most of obliquely incident light. A thin film having low-pass or band-pass spectral reflectance characteristics may potentially have such characteristics.

The first polarization beam splitting film 28 have a transmittance relative to oblique incident light, which varies depending on the position along the x-direction. For example, the first polarization beam splitting film 28 is formed to have a transmittance that increases in geometric progression according to the distance from one end on the incident region side of the first polarization beam splitting film 28. In order to form such film through evaporation, for example, the first plane S1 may be disposed such that the distance from the evaporation source may vary depending on the planer distance from the first region, and may be designed in advance so as to have a desired reflection characteristic at each position based on the difference in the distance (difference in thickness of the film to be formed).

The first light guide portion 25 is a plate-like member in a rectangular shape longer in the x-direction (for example, 60 mm) and shorter in the y-direction (for example 20 mm), with a thickness, i.e., the length in the z-direction, of several mm (for example, 3 mm), and uses quartz (transparent medium) as the material. The use of quartz as the first light guide portion 25 offers advantages that it provides thermal resistance against heat applied when evaporating the first polarization beam splitting film 28 and its hardness prevents warping under film stress. An AR film (not shown) is formed on the first plane S1 of the first light guide portion 25. The AR film suppresses reflection of image light incident from a direction perpendicular to the AR film.

The first diffractive element 26 is a reflective diffractive element diffracting image light incident from an incident region of the first light guide portion 25, so as to tilt the image light toward the x -direction. The first diffractive element 26 is designed to have a diffraction efficiency higher in the first order diffraction direction, relative to the wavelength of the image light. The first diffractive element 26 may use, for example, a blazed diffraction grating having a saw-toothed section, in which grooves extending in the y-direction are arranged in the x-direction. The first diffractive element 26 has parameters such as a lattice constant, which are designed such that image light incident from the incident region and deflected as being diffracted by the first diffractive element 26 is totally reflected by the first plane S1 inside the first light guide portion 25. That is, image light propagating within the first light guide portion 25 has an incident angle relative to the first plane S1 which is larger than a critical angle. For example, the critical angle is 43.6° when the first light guide portion 25 is formed of quartz.

The first prism array 27 is in a shape in which triangular prisms are aligned in the x-direction, the triangular prisms each having an x-z section longer in the y-direction of the triangle. The triangular prisms are each composed of a plane tangent to the second plane S2, a plane substantially perpendicular to the second plane S2, and a slope So. The triangular prism is made of a transparent medium such as acrylic, and is formed by injection molding. The slope So of each triangular prism has aluminum evaporated thereon, and is inclined as having the normal inclined toward the incident region side. The inclination of the slope So is so defined that, of the image light, a light beam perpendicularly incident on the incident region to be first-order diffracted by the first order diffractive element 26 so as to propagate within the first light guide portion 25 to transmit through the first polarization beam splitting film 28 to be incident on the triangular prism array is reflected perpendicularly toward the first plane S1.

In the first propagation optical system 22 configured and arranged as described above, as illustrated in FIG. 4, a first light beam b1 (indicated by the broken line in FIG. 4) perpendicularly incident on an incident region of the first plane S1 is reflected as being first-order diffracted by the first diffractive element 26 bonded to the second plane S2, so as to travel toward first plane S1 as being parallel with the xy plane while being inclined to the first plane S1. The first light beam b1 traveling toward the first plane S1 is incident on the first plane S1 at an angle exceeding a critical angle and totally reflected. The totally-reflected first light beam b1 travels toward the second plane S2, so as to be obliquely incident on the first polarization beam splitting film 28 formed on the second plane S2 to pass through by an amount of a predetermined ratio, with the rest being reflected. The first light beam b1 reflected by the first polarization beam splitting film 28 is re-incident on the first plane S1 at an angle exceeding a critical angle, and totally reflected. Thereafter, the first light beam b1 is repeatedly subjected to partial reflection at the first polarization beam splitting film 27 and to total reflection at the first plane S1, so as to be propagated within the first light guide portion 25 in the x-direction. However, every time the light beam is incident on the first polarization beam split film 28, the light transmits therethrough at a predetermined ratio to be emitted to the first triangular prism array 27.

The first light beam b1 emitted to the first triangular prism array 27 is reflected again in a direction perpendicular to the second plane S2 of the first light guide portion 25, by a reflection film on each of the slopes So of the first triangular prism array 27. The first light beam b1 reflected in a perpendicular direction passes through the first light guide portion 25 to be emitted outside from the first plane S1.

The half-wave plate 23 (see FIG. 3) is formed in a shape substantially in the same size as the emitting region of the first plane S1. The half-wave plate 23 is disposed at a position opposing to the emitting region of the first plane S1, by providing a gap therebetween. Accordingly, a light flux incident on the first plane S1 within the first light guide portion 25 at an angle equal to or larger than the critical angle is guaranteed to be totally reflected without transmitting through the first plane S1. As described above, the half-wave plate 23 rotates, by 90°, the polarization plane of a light flux emitted from the first propagation optical system 22.

The second propagation optical system 24 is similar in configuration to the first propagation optical system 22, except the size and the arrangement. As illustrated in FIG. 3, the second propagation optical system 24 is configured by including: a second light guide portion 31; a second polarization beam splitting film (not shown); a second diffractive element 32 (second input deflector); and a second prism array 33 (second output deflector). Similarly to the first propagation optical system 22, these components are integrally formed in a flat plate-like shape, and has lengths in the width direction (“x-direction” of FIG. 3) and in the length direction (“y-direction” of FIG. 3) of the second propagation optical system 24 and of the second light guide portion 31, which are, for example, 50 mm and 110 mm, respectively. Further, the second polarization beam splitting film in the second propagation optical system 24 has a length of, for example 100 mm in the longitudinal direction (y-direction). Further, the second diffractive element 32 has a length of, for example, 10 mm in the y-direction. The second light guide portion 31, the second polarization beam splitting film, the second diffractive element 32, and the second triangular prism array 33 are similar in function to the first light guide portion 25, the first polarization beam splitting film 28, the first diffractive element 26, and the first triangular prism array 27, respectively.

In the second propagation optical system 24, the emitting region of the first plane S1 of the first propagation optical system 22 and the incident region of the third plane S3 of the second propagation optical system 24 are opposing to each other, and the second propagation optical system 24 is disposed as being rotated by 90° about a straight line parallel to the first propagation optical system 22 in the z-direction (see FIG. 3). Accordingly, image light emitted from the first propagation optical system 22 is expanded in the y.-direction and emitted by the second propagation optical system 24. In this manner, the exit pupil is expanded.

Next, with reference to FIG. 4, description is given of an optical path of a second light beam b2 incident at an incident angle θi on an incident region of the first propagation optical system 22. The second light beam b2 is deflected in the emitting region direction by the first diffractive element 26 to be incident on the first plane S1 in the first light guide portion 25 at an angle equal to or larger than a critical angle, and totally reflected. The second light beam b2 totally reflected by the first plane S1 is incident on the second plane S2, where part of the light amount thereof transmits through the first polarization beam splitting film 28 to be reflected by the slopes So of the first triangular prism array 27. The second light beam b2 reflected by the slope So transmits through the first polarization beam splitting film 28 on the second S2 to pass through the first light guide portion 25 to be emitted from the first plane S1. Here, the second light beam b2 is emitted from the first plane S1 at the exit angle θo inclined according to the incident angle θi.

For example, the incident angle θi and the exit angle θo have a relation as shown in Table 1, in which the order of diffraction (m) is −1, the wavelength (λ) of the image light is 532 nm, the refractive index (n) of the first triangular prism array 27 is 1.51, and the diffraction grating period (d) is 450 nm.

TABLE 1
Exit Angle relative to Incident Angle in First Propagation Optical
System

| Incident Angle (θi) | Exit Angle (θo) |
|---|---|
| 10° | −14.6° |
| 8° | −11.9° |
| 6° | −9.1° |
| 4° | −6.2° |
| 2° | −3.1° |
| 0° | 0.0° |
| −2° | 3.3° |
| −4° | 6.8° |
| −6° | 10.5° |
| −8° | 14.5° |
| −10° | 18.9° |

As is apparent from Table 1, the use of the first diffraction grating element 26 for diffracting image light in the incident region makes the exit angle θo to be larger than the incident angle θi. No such effect of expanding the exit angle can be seen when a mirror or a half-mirror is used for deflecting image light both in the incident region and the emitting region of the first and second light guide portions 25, 31. When a mirror is used both in the incident region and the emitting region, the incident angle θi and the exit angle θo become equal to each other. Further, when a diffractive element is used both in the incident region and the emitting region, the incident angle θi and the exit angle θo again become equal to each other. As described above, the exit angle θo can be expanded, which allows for reducing the incident angle θi to be relatively small. In other words, the field angle of image light incident from the projection optical system 11 can be reduced to small.

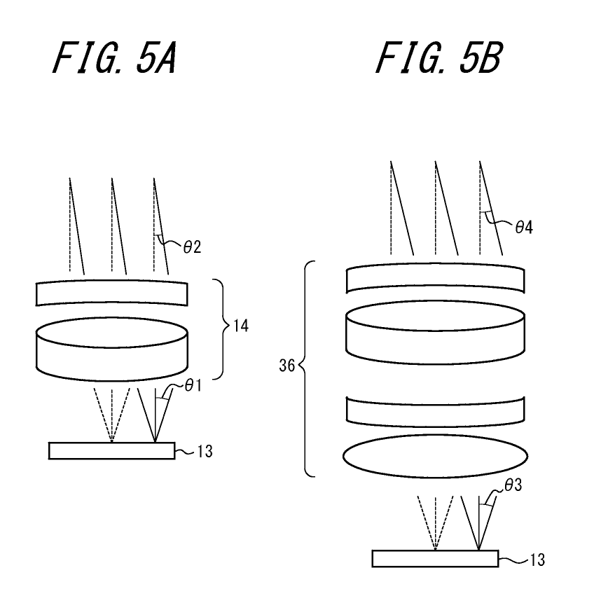

FIG. 5A illustrates a schematic configuration of the projection optical system 11, the configuration of which has already been described with reference to FIG. 2. Here, θ1 indicates the divergence of image light emitted from the LCD 13, and θ2 indicates the field angle of image light projected toward the exit pupil that has transmitted through the collimator 14. The field angle that can be displayed by the image display device relates to the field angle θ2 at which a virtual image is projected at infinity by the projection optical system 11 at the exit pupil. In general, the display field angle of the image display device 10 is the same as the field angle of the projection optical system, and thus, the conventional image display device 10 includes a collimator 36 composed of a multiple optical elements which are arranged for suppressing an aberration in order to expand the field angle θ4 of the projection optical system 11 as illustrated in FIG. 5B. In contrast, in the disclosed image display device 10, the first propagation optical system 22 and the second propagation optical system of the pupil expanding optical system 12 have an effect of expanding the exit angle, which means that the field angle of the exit pupil can be expanded so as to display an image at a larger viewing angle than the incident image light. Accordingly, the number of lenses can be reduced or the device can be downsized due to the reduced focal length, as illustrated in FIG. 5A.

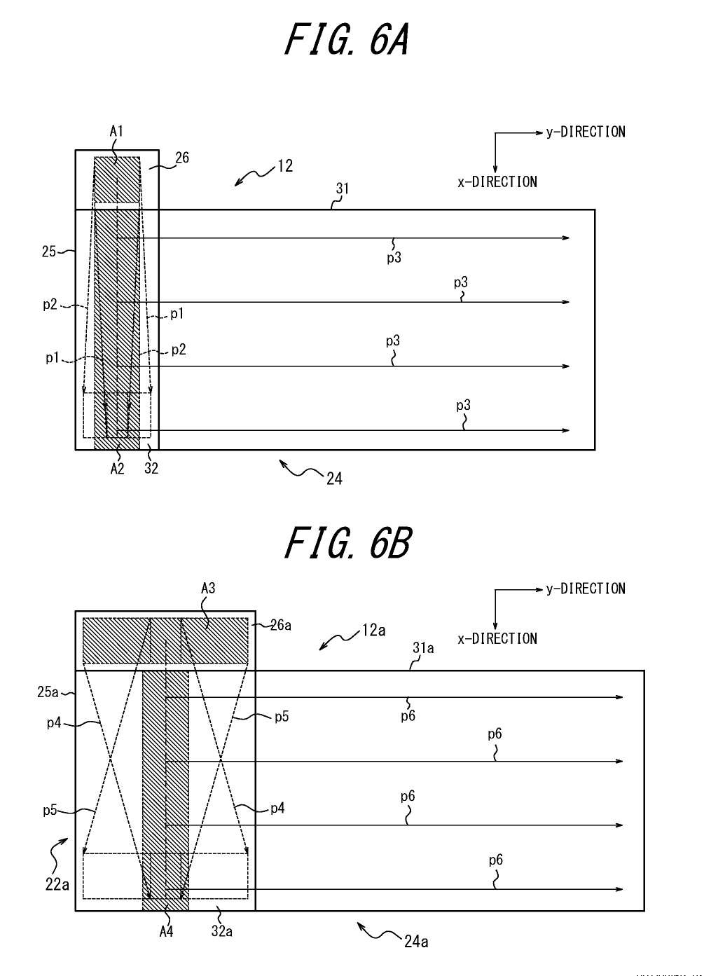

FIG. 6A is for illustrating propagation of image light in the pupil expanding optical system 12 of FIG. 1, and FIG. 6B is for illustrating propagation of image light in a conventional pupil expanding optical system 12a. FIGS. 6A and 6B view the pupil expanding optical systems 12, 12a in the z-direction. In FIG. 6B, constituent elements similar in function to those of Embodiment 1 are denoted by the same reference numerals of Embodiment 1, with the addition of “a”.

In the conventional pupil expanding optical system 12a, which has a large field angle of image light from the projection optical, image light fluxes propagating through the first propagation optical system 22a has a component that largely shifts in the y-direction, as indicated by a light flux p4 shifting in the most +y-direction and a light flux p5 shifting in the most −y-direction in FIG. 6B. Thus, in order to prevent vignetting of a light beam and image unevenness, an image light incident region A3 (i.e. the incident region of the first light guide portion 25a) needed to be defined larger in the y-direction while limiting the width in the y-direction in a range where the image lights in the +y- and −y-directions overlap each other, so as to define an emitting region A4 of the first propagation optical system 22a (i.e., the emitting region of the first light guide portion 25a). As a result, image light incident from the projection optical system 11 has been lost for the most part in the first propagation optical system 22.

In contrast, in the disclosed pupil expanding optical system 12 of Embodiment 1, where the field angle of image light from the projection optical system 11 is narrow and the field angle of light propagating through the first light guide portion 25 in the y-direction is equal to the field angle of image light from the projection optical system 11 (because the expansion of the exit angle in the first propagation optical system 22 is only effected in the x-direction), image light fluxes propagating through the first propagation optical system 22 have a light flux p1 shifting in the most +y direction and a light flux p2 shifting in the most −y direction which are both shifted in the y-direction by a relatively smaller amount as illustrated in FIG. 6A as compared with FIG. 6B. Therefore, an image light incident region A1 of the first propagation optical system 22 (i.e., the incident region of the first light guide portion 25) can be made smaller. As a result, the first propagation optical system 22 can be made compact in size. Further, image light incident from the projection optical system 11 can be propagated as light fluxes p3 to the second propagation optical system 24 with high efficiency, without being lost in the first propagation optical system 22. Further, the incident pupil of the pupil expanding optical system 12 may be made small, which allows the projection optical system 11 to be made further smaller in size.

Now, referring again Table 1, the incident angle θi and the exit angle θo have a nonlinear relation, which means that an image to be displayed on the LCD 13 undergoes distortion as having propagated through the disclosed first propagation optical system 22 and the second propagation optical system 24. In light thereof, the image controller 16 of FIG. 1 generates an image signal previously given an opposite distortion as an image signal of an image to be displayed on the LCD 13, so as to offset distortion to be generated through the first propagation optical system 22 and the second propagation optical system 24. This configuration allows for displaying an image with no distortion. The method of compensating distortion is not limited to the above. For example, instead of providing the image controller 16, the pixels of the LCD may be non-linearly aligned according to distortion to be generated due to the first propagation optical system 22 and the second propagation optical system 24, to thereby compensate the distortion.

As described above, according to Embodiment 1, the first propagation optical system 22 and the second propagation optical system 24 are configured to use diffraction for the deflection on the incident side while using reflection for the deflection on the emitting side, to thereby reduce the number of components in the projection optical system 11 so as to downsize the system while ensuring a sufficient display field angle of the image display device 10.

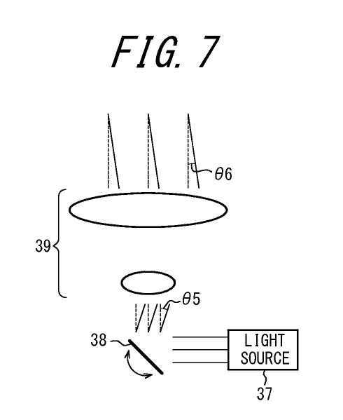

Here, in Embodiment 1, the projection optical system 11 projects an image on the LCD 13, while the projection optical system 11 may employ a MEMS mirror. Referring to FIG. 7, a projection optical system in this case is described in terms of configuration, operation, and effect thereof. The rest of the components other than the projection optical system is the same as Embodiment 1.

The projection optical system of FIG. 7 is configured by including: a light source 37; a MEMS mirror 38; and a beam expander 39. The light source 38 is a laser light source, which can be switched ON/OFF at high speed. The MEMS mirror 38 is a mirror element which repeats two-dimensional scan at high frequency. The light source 37 expands a beam diameter correspondingly to a mirror surface of the MEMS mirror 38, and irradiates the MEMS mirror 39 with the beam. The beam expander 39 is disposed between the MEMS mirror 38 and the pupil expanding optical system 21, expands a light beam reflected by the MEMS mirror 38, and transfers the light beam to the incident pupil of the pupil expanding optical system 21, that is, the incident region of the first light guide portion 25. The MEMS mirror 38 and the incident region of the first light guide portion 25 are optically conjugate to each other.

The light source 37 is controlled by a control unit (not shown), and emits light at an emission timing corresponding to the image to be displayed, in accordance with the tilting of the MEMS mirror 38. The beam expander 39 expands a beam diameter reflected by the MEMS mirror 38, corresponding to the incident region of the first light guide portion 25. As explained in Embodiment 1, image light incident on the incident region of the first light guide portion 25 is emitted toward the observer with the exit pupil expanded by the pupil expanding optical system 12

Here, in the case where the projection optical system of FIG. 7 is used, when the beam expander 39 expands the beam diameter, the exit angle θ6 of image light from the beam expander 39 is reduced relative to the incident angle θ5. For this reason, a conventional image display device would have required the MEMS mirror 38 to be increased in size in order to obtain a larger field angle in the image display device 10. However, when the MEMS mirror 38 is increased in mirror area, the mirror scan frequency and the deflection angle of the mirror cannot be increased in general.

On the other hand, according to the disclosed device, the incident field angle of image light incident on the pupil expanding optical system 12 is expanded by the first and second propagation optical systems 22 and 24 before being emitted, which eliminates the need to use, in the projection optical system, a MEMS mirror that is large in area or to increase the deflection angle of the MEMS mirror. Accordingly, the projection optical system can be configured compact. Further, the MEMS mirror can be scanned at high frequency, which allows for displaying an image at higher frame rate.

### Embodiment 2

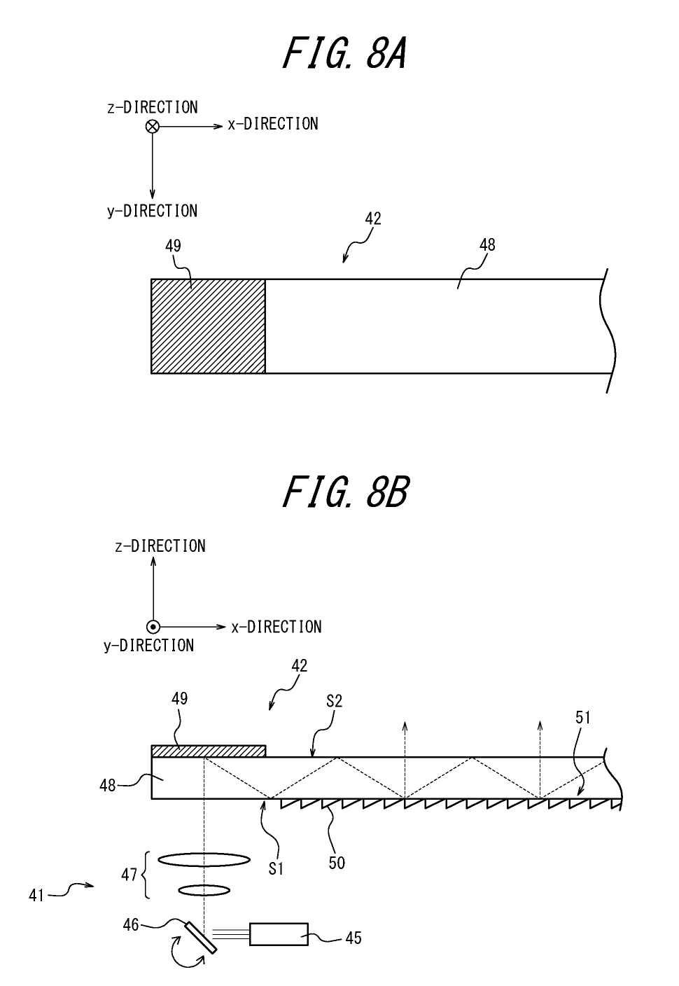

FIG. 8 each illustrate a schematic configuration of the disclosed image display device according to Embodiment 2, in which FIG. 8A is a front view and FIG. 8B is a top view. The disclosed image display device according to Embodiment 2 is different the one according to Embodiment 1 in that the exit pupil is expanded only in the x-direction by a propagation optical system 42 (first propagation optical system).

The projection optical system 41 includes: a light source 45; a MEMS mirror 46; and a beam expander 47. The configuration is similar to that of the projection optical system of FIG. 7, and thus the description thereof is omitted. The propagation optical system 42 includes a light guide portion 48, a diffractive element 49, a triangular prism array 50, and a polarization beam splitting film 51. The light guide portion 48 is a flat plate-like member similar to the first light guide portion 25 of Embodiment 1. The diffractive element 49 is, similarly to the first diffractive element 26 of Embodiment 1, disposed onto a plane (second plane S2) opposing to the incident region of image light of the light guide portion 48 at the end on the incident side, and has similar functions. Further, the polarization splitting film 51 and the triangular prism array 50, which have the same shape and properties as those of the first polarization beam splitting film 28 and the first triangular prism array 27 of Embodiment 1, are however disposed in an area other than the incident region of a plane (first plane S1) on the incident side of image light incident on the light guide portion 48, unlike Embodiment 1. Here, image light incident on the propagation optical system 42 from the projection optical system 41 is S-polarized light. A polarizer, which is not shown, may also be disposed between the projection optical system 41 and the propagation optical system 42.

With the aforementioned configuration, image light emitted from the projection optical system 41 is incident on the light guide portion 48 from the first plane S1 of the light guide portion 48 and diffracted on the diffraction plane of the diffractive element 49 bonded to the second plane S2 to be propagated within the light guide portion 48 in the x-direction. Part of amount of the image light diffracted toward the first plane S1 within the light guide portion passes through the polarization beam splitting film 51 on the first plane S1 to be reflected by the triangular prism array 50 in a direction perpendicular to the first plane S1 and passes through inside the light guide portion 48 to be emitted from the second plane S2. The image light reflected by the polarization beam splitting film 51 travels through within the light guide portion 48 diagonally relative to the x-direction and is totally reflected again by the second plane S2 to travel in the first plane direction, which is repeated thereafter.

In this manner, image light having an exit pupil expanded in the x-direction is emitted from the second plane S2 of the light guide portion 48. As described above, the use of the propagation optical system 42 propagating image light in one direction still has an effect of expanding the pupil in the propagating direction of the image light. Further, the diffractive element 26 is used to diffract image light on the incident side of the light guide portion 48 while using the triangular prism array 50 which serves as a mirror surface for the deflection on the emission side, to thereby expand the field angle of incident light as in Embodiment 1 before emitting the light.

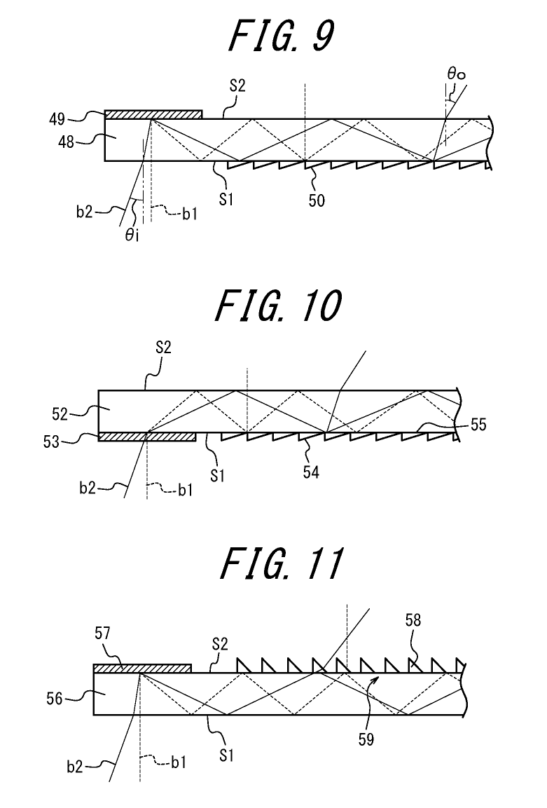

FIG. 9 is a top view of the incident part of the propagation optical system of FIG. 8A, illustrated along with a path of image light. The first light beam b1 shows image light perpendicularly incident on the light guide portion 48, and the second light beam b2 shows image light incident thereon at an incident angle θi. When the second light beam b2 is emitted from the light guide portion 48 at an exit angle θo, the incident angle θi and the exit angle θo have the following relation.

TABLE 2
Exit Angle relative to Incident Angle of Propagation Optical System

| Incident Angle (θi) | Exit Angle (θo) |
|---|---|
| 10° | 18.9° |
| 8° | 14.5° |
| 6° | 10.5° |
| 4° | 6.8° |
| 2° | 3.3° |
| 0° | 0.0° |
| −2° | −3.1° |
| −4° | −6.2° |
| −6° | −9.1° |
| −8° | −11.9° |
| −10° | −14.6° |

Here, similarly to Embodiment 1, the order of diffraction (m) is −1, the wavelength (λ) of the image light is 532 nm, the refractive index (n) of the first triangular prism array 27 is 1.51, and the diffraction grating period (d) is 450 nm.

As can be appreciated from Table 2, the exit angle θo is larger than the incident angle θi even when the incident side plane of the light guide portion 48 is different from the emission side plane thereof. Therefore, the incident angle θi can be made relatively small, which can downsize the projection optical system 41. Further, the MEMS mirror 46 is compact enough to be scanned at high frequency.

Various aspects are conceivable as the propagation optical system as described above for expanding a pupil in a one-dimensional direction. Examples of such aspects are illustrated in below.

FIG. 10 illustrates a modified example of the disclosed propagation optical system. In the propagation optical system of FIG. 10, a transmission diffractive element 53 is connected to the first plane S1 on the incident side of image light incident on the light guide portion 52. Further, a polarization beam splitting film 55 and a triangular prism array 54 are disposed on the first plane S1 on the incident side of image light incident on the light guide portion 52. With this configuration, image light is incident on the first plane S1 and emitted from the second plane S2.

FIG. 11 illustrates another modified example of the disclosed propagation optical system. According to the configuration of the propagation optical system, the second plane S2 opposing to the first plane S1 on the incident side of image light incident on the light guide portion 56 has a reflective refractive element 57 disposed thereon as opposing to the incident region of image light. Further, a polarization beam splitting film 59 is evaporated onto the second plane S2, on which a triangular prism array 58 formed of a polished surface is further arranged. Unlike the triangular prisms of Embodiments 1, 2, the slopes of the triangular prism array 58 have no aluminum evaporated thereon and are configured to transmit image light therethrough. Image light that has been incident on the second plane S2 of the light guide portion 56 to transmit through the polarization beam splitting film 59 is partially deflected as being refracted by the slopes of the triangular prisms, so as to be emitted in a direction substantially perpendicular to the second plane S2.

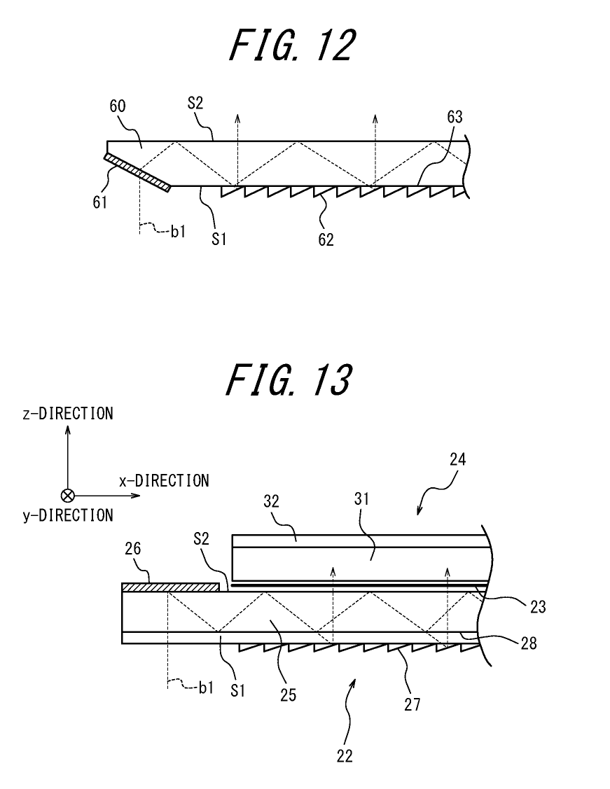

FIG. 12 illustrates further another modified example of the disclosed propagation optical system. According to the configuration of the propagation optical system, the incident region of the first plane S1 on the incident side of image light of the light guide portion 60 is obliquely cut out to form a slope having the normal inclined toward the x-direction, and a transmission diffractive element 61 is disposed on the slope thus formed. Further, a polarization beam splitting film 63 is evaporated onto the rest of the first plane S1, on which a triangular prism array 62 is further connected. Image light incident on this propagation optical system is diffracted by the diffractive element 61 to be deflected, and propagates inside the light guide portion 60 as in Embodiment 2, so as to be emitted from the second plane S2 in a direction substantially perpendicular to the second plane S2.

### Embodiment 3

Two of the transmission propagation optical systems according to Embodiment 2, in which the incident surface is different from the emitting surface of image light, may be combined so as to form a pupil expanding optical system which expands the pupil in the x -direction and the y-direction as in Embodiment 1. FIG. 13 is a sectional view of the disclosed pupil expanding optical system according to Embodiment 3 configured as above, along with an optical path of image light. The system of FIG. 13 is similar in configuration to the pupil expanding optical system 12 of Embodiment 1, and thus, like constituent elements are denoted by like symbols. Constituent elements denoted by the same symbols are similar in configuration to those of Embodiment 1 unless otherwise specified.

In Embodiment 3, the first propagation optical system 22 and the second propagation optical system 24 are transmission propagation optical systems similar to the propagation optical system 48 of FIG. 9, in which the incident surface is different from the emitting surface. The half-wave plate 23 is disposed between the first propagation optical system 22 and the second propagation optical system 24. The first light guide portion 25 of the first propagation optical system 22 is different from the light guide portion 48 of FIG. 9 according to Embodiment 2 only in that the first polarization beam splitting film 28 is formed on the inside than a surface on the incident side of image light incident on the first light guide portion 25. To form the first light guide portion 25 as described above, a polarization beam splitting film may be evaporated onto one surface of one of the members of the two transparent plate-like members, and the other member may be bonded, through transparent adhesives, on a surface where the polarization beam splitting film is formed.

Image light incident on the first light guide portion 25 is diffracted by the first diffraction element 26, so as to be partially transmitted through the first polarization beam splitting film 28 while the rest is reflected, and is totally reflected on the second plane S2. Then, the image light is propagated in the x-direction while repeatedly reflected between the first polarization beam splitting film 28 and the second plane S2. Accordingly, in Embodiment 3, a plane formed with the first polarization beam splitting film 28 corresponds to the first plane S1. Image light having transmitted through the first polarization beam splitting film 28 is reflected by the first triangular prism array 27 to pass through inside the first light guide portion 25, so as to be emitted from the second plane S2 in a direction substantially perpendicular to the second plane S2.

Image light emitted from the second plane S2 is rotated in polarization direction by 90 degrees by the half-wave plate 23 so as to be incident on the second propagation optical system 24 as S-polarized light. The second propagation optical system 24 is similarly configured as the first propagation optical system 22 of Embodiment 1, except the size and orientation thereof. With this configuration, image light incident on the second propagation optical system 24 and diffracted by the second diffractive element 32 are repeatedly reflected within the second light guide portion 31, while propagating in the y-direction so as to be emitted from the fourth plane S4 opposing to the plane on the incident side.

As described above, Embodiment 3 can provide an image display device having an exit pupil expanded in the x-direction and in the y-direction, as in Embodiment 1. Then, in the first propagation optical system 22 and the second propagation optical system 24, image light is diffracted to be deflected on the incident side while being reflected to be deflected on the emitting side, to thereby reduce the number of components in the projection optical system and downsize the system while ensuring a sufficient display field angle of the image display device 10.

Although the disclosed device has been described with reference to the drawings and Examples, various modifications and alterations thereof are readily available to a person skilled in the art based on the present disclosure. Thus, it should be noted that such modifications and alterations should all fall within the range of the disclosure. For example, the dimension, shape, and arrangement of each component described each embodiments are illustrated as mere examples; various sizes, dimensions, shapes, and arrangements are applicable within the range of the present disclosure. The first and second propagation optical systems, which are not limited those exemplified herein, may use a diffractive element for the diffraction on the incident side while using reflection and a refractive element for the diffraction on the emission side without departing from the scope of the present disclosure.

### REFERENCE SIGNS LIST

10 image display device

11 projection optical system

12 pupil expanding optical system

13 LCD

14 collimator

15 exit pupil

16 image controller

21 polarizer

22 first propagation optical system

23 half-wave plate

24 second propagation optical system

25 first light guide portion

26 first diffractive element

27 first triangular prism array

28 first polarization beam splitting film

31 second light guide portion

32 second diffractive element

33 second triangular prism array

36 collimator

37, 45 light source

38, 46 MEMS mirror

39, 47 beam expander

41 projection optical system

42 propagation optical system

48, 52, 56, 60 light guide portion

49, 53, 57, 61 diffractive element

50, 54, 58, 62 triangular prism array

51, 55, 59, 63 polarization beam splitting film

1. An image display device, comprising:
a projection optical system projecting, at infinity, image light corresponding to an arbitrary image; and a first propagation optical system,
the first propagation optical system including:
a first input deflector deflecting the image light emitted from the projection optical system;
a first light guide portion formed like a plate having a first plane and a second plane parallel and opposing to each other, the first light guide portion propagating in the first direction the image light deflected by the first input deflector, between the first plane and the second plane while causing the image light to be repeatedly reflected therebetween; and
a first output deflector deflecting through reflection or refraction, in a direction substantially perpendicular to the first plane, part of image light propagating through the first light guide portion, while deflecting the image light such that an incident angle at which the image light is incident on the first input deflector and an exit angle at which the image light having propagated through the light guide portion have a non-linear relation.

2. The image display device according to claim 1, wherein the projection optical system projects image light corrected based on non-linearity between the incident angle at which the image light is incident on the first input deflector and the exit angle at which the image light having propagated through the first light guide portion is emitted from the first output deflector.

3. The image display device according to claim 1, further comprising a second propagation optical system including:
a second input deflector diffracting the image light deflected by the first output deflector and emitted from the first propagation optical system;
a second light guide portion formed like a plate having a third plane and a fourth plane parallel and opposing to each other, the second light guide portion propagating, in a second direction substantially perpendicular to the first direction, the image light deflected by the second input deflector, between the third plane and the fourth plane while causing the image light to be repeatedly reflected therebetween; and
a second output deflector deflecting through reflection or refraction, in a direction substantially perpendicular to the third plane, part of the image light propagating through the second light guide portion.

4. The image display device according to claim 3, wherein the projection optical system projects image light corrected based on non-linearity between the incident angle at which the image light is incident on the first input deflector and the exit angle at which the image light having propagated the light guide portion is emitted from the second output deflector.

5. The image display device according to claim 1, wherein the first input deflector has a diffraction grating pattern periodically arranged in the first direction.
